(19) United States
(12) Patent Application Publication
(10) Pub. No.: US 2022/0021542 A1
(43) Pub. Date: Jan. 20, 2022

(54) LOW LATENCY IMMUTABLE DATA INTEGRITY

(71) Applicant: Raytheon Company, Waltham, MA (US)

(72) Inventor: Stacey L. Franklin, Hawthorne, CA (US)

(21) Appl. No.: 16/928,906

(22) Filed: Jul. 14, 2020

(51) Int. Cl. H04L 9/32; H04L 9/30

(52) U.S. Cl. CPC H04L 9/3247; H04L 9/30; H04L 9/3239

(57) ABSTRACT

Devices, systems, and methods for secure communication. A method includes generating, at least partially by a first device, an asymmetric key pair including a private signing key and a corresponding public verification key. Before providing the public verification key or a value used to generate the public verification key to a second device, the method includes requesting and receiving a keyless signature from a keyless signature infrastructure (KSI) for the public verification key or a value used to generate the public verification key. The method further includes providing the KSI signature and (a) the public verification key or (b) the value used to generate the public verification key to the second device, and communicating a first message to the second device, the first message signed using the private signing key.

### TECHNICAL FIELD

Embodiments discussed herein regard devices, systems, and methods for data accuracy and consistency assurance over time.

### BACKGROUND

The Current State-of-the-Art for secure information exchange is the Public Key Infrastructure (PKI). It operates fast, and it provides good integrity; however, because of significant security risks due to its complex infrastructure, PKI cannot provide persistent, immutable integrity. PKI can detect modifications made since a last signing. A weakness of PKI includes, if the private key is stolen/compromised an adversary can spoof/forge a valid signature, meaning it is possible that the original signature may not persist throughout the signed object's lifecycle.

Alternatively, blockchain technologies can assure immutable data integrity; however, these technologies add significant time overhead to commit a message to the blockchain. In practice, this means a data recipient may have to wait several minutes before they can verify that the message they received was correct. Additionally, blockchains often expose the message data to the ledger. That is, they provide immutable data integrity, but must sacrifice both speed and secrecy. There have been a handful of implementations of “blockchain-based PKI”, wherein PKI public keys, rather than the actual messages themselves, are stored in a blockchain. This overcomes one of the barriers to achieving immutable data integrity, but it still falls short, since the underlying system is still PKI based, and therefore all the security risks inherent in PKI-based systems remain.

One technology, Keyless Signature Infrastructure (KSI) largely addresses this problem, but not completely. KSI can provide persistent, immutable data integrity. In KSI, an aggregated hash from a top-level core node is generated approximately once per second. The message hashes are aggregated and hashed with other message hashes through several layers of aggregation in a Merkle Tree. The resultant hash is then again aggregated with prior hash values. The resultant hash is published in a widely distributed manner and sent back to the originator. The message originator then sends the message to the recipient(s) along with the message's associated Merkle Tree, which is the message's keyless signature. The recipient can then re-perform the hash calculations according to the keyless signature, and then compare that resultant hash value to the one that was widely distributed, thereby verifying the signature. The wide distribution of the resultant hash value combined with the collision resistance and pre-image resistance properties of hashes makes it mathematically impossible to forge a signature for a message. Also, message confidentiality is preserved, as message hashes, not the messages themselves, are provided to the KSI infrastructure.

Additionally, hash calculations are fast to compute, and therefore KSI can meet shorter communications timelines while still providing immutable integrity. Yet, the speed of KSI still has its limits. The time it takes for a hash value to be aggregated up the chain and then for the resultant hash value to be widely distributed does carry some overhead such that KSI does not guarantee timeline requirements less than four (4) seconds. So, while current KSI technology is faster than other technologies, a solution is still needed that can reliably provide immutable data integrity in communications with timeline requirements less than four (4) seconds.

### BRIEF DESCRIPTION OF THE DRAWINGS

FIG. 1 illustrates, by way of example, a diagram of an embodiment of a system for secure communication.

FIG. 2 illustrates, by way of example, a communication diagram of an embodiment of communication between the sender and the receiver.

FIG. 3 illustrates, by way of example, a diagram of an embodiment of the KSI infrastructure.

FIG. 4 illustrates, by way of example, a diagram of an embodiment of a method for secure communication.

FIG. 5 illustrates, by way of example, a block diagram of an embodiment of a machine in the example form of a computer system within which instructions, for causing the machine to perform any one or more of the methodologies discussed herein, may be executed.

### DETAILED DESCRIPTION

Embodiments provide methods, systems, devices, and computer-readable media for immutable data integrity. Embodiments can provide a low latency communication with immutable data integrity. Low latency, as used herein, means reliably less than four (4) seconds. “Reliably” means that some threshold percentage of communications are provided in a time that is less than the low latency standard (e.g., four (4) seconds). The threshold percentage can be 50%, 75%, 90%, 95%, 99%, 99.9%, or some percentage therebetween.

For one communication direction, a sender can generate a public key and private key pair. The public key and private key pair can be generated sufficiently in advance of needing to begin communications, such that the key generation does not affect the communication timeline. The sender can sign a public key with KSI, such as by generating a KSI signature for the public key. The sender can send a KSI-signed public key to a recipient. The recipient can verify the public key via the KSI signature. Then communication can begin. Keyless signatures are not vulnerable to key compromise and hence provide a solution to the long-term validity of digital signatures.

The sender can sign the message with the previously-generated private key. The sender can send the message and signed hash to the recipient. The recipient can verify the signed hash with the public key. The recipient can calculate the hash of the message. The recipient can compare the calculated hash to the signed hash.

A public and private key pair can be destroyed and a new private and public key can be created. The epoch (time period) during which a particular key pair is valid can be configurable and use-case-specific. The epoch can be selected to be significantly less than the theoretical minimum time needed by an adversary to brute force the private key from the public key. This can effectively mitigate the risk associated with a compromised private key.

Persistent, immutable integrity can be achieved by KSI-backed asymmetric cryptography. High speed can be achieved by only signing the hash of the message (not the whole message) and by only taking the time to get a KSI signature for the public key (not every message). This provides immutable integrity where the communication timeline is only impacted by the time it takes to perform a cryptographic signing for a single small hash value and the time it takes to calculate a single hash, which is on the order of milliseconds.

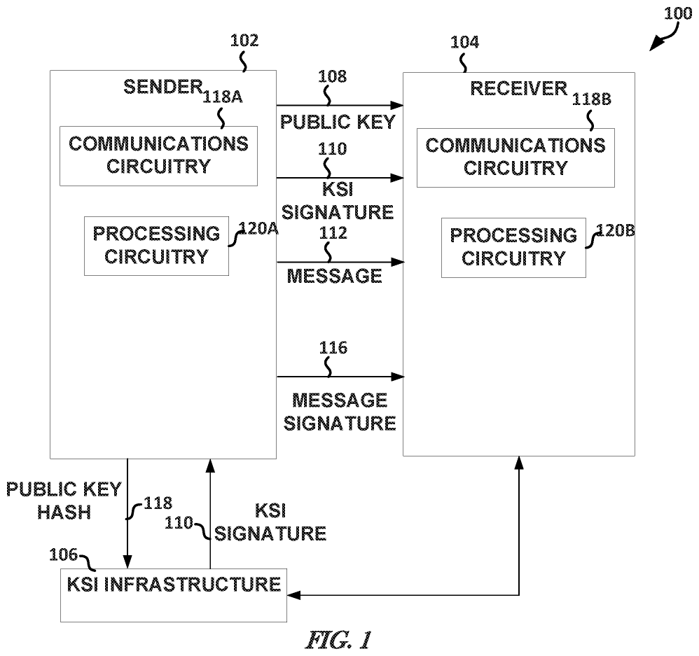

FIG. 1 illustrates, by way of example, a diagram of an embodiment of a system 100 for secure communication. The system 100, as illustrated, includes a sender 102, a receiver 104, and a KSI infrastructure 106. The sender 102, as illustrated, is communicatively coupled to the receiver 104 and the KSI infrastructure 106 (not necessarily simultaneously). The sender 102 and the receiver 104 include communications circuitry 118A, 118B, respectively, and processing circuitry 120A, 120B, respectively. Some variable portion of the KSI infrastructure 106 may be hosted on the processing circuitry 120A, 120B of the sender 102 or the receiver 104. For example, a gateway and a lowest level aggregator may be hosted on the processing circuitry 120A-120B. More details regarding the gateway and the aggregator are provided elsewhere herein.

The sender 102, receiver 104, or a combination thereof can include a device capable of wired or wireless communication with the receiver 104 and the KSI infrastructure 106. The sender 102, receiver 104, or a combination thereof can include an autonomous or non-autonomous vehicle (e.g., an airplane, boat, ship, car, truck, drone, or the like), a smartphone, an intelligence, surveillance, or reconnaissance (ISR) device (e.g., a satellite or other air, ground, or water-based environment monitor), a computing device (e.g., a laptop, tablet, desktop, or other computer, an appliance, or the like), among others.

The KSI infrastructure 106 is a globally distributed network for the issuance and verification of KSI signatures. Unlike public key infrastructure (PKI) that depends on asymmetric key cryptography, KSI uses only hash-function cryptography. This allows verification to rely only on the security of hash functions and the availability of a publicly available, verifiable source, such as can be similar to a public ledger or other blockchain-like mechanism. The sender 102 or receiver 104 can interact with the KSI infrastructure 106 by submitting the data to be signed, which can include a hash value of the data, an encrypted value of the data, or the raw data, or a combination thereof, to be signed to the KSI infrastructure 106. The KSI infrastructure 106 can then return to the sender 102 or receiver 104 a signature which provides cryptographic proof of the time of signature and integrity of the signed data. The signature can also include attribution of origin (which entity generated the signature). More details regarding KSI operations are provided elsewhere herein.

Public key encryption (PKE), sometimes called public-key cryptography, or asymmetric cryptography, is a cryptographic system that uses pairs of public and private keys. The public key can be disseminated widely while the private key is known only to the owner. The generation of such keys depends on cryptographic techniques based on mathematical problems to produce functions that are difficult to reverse without the key. Effective security requires keeping the private key private, which is a weakness of PKE. However, the public key can be openly distributed without compromising security. A sender can perform a “signing” algorithm on a message with a private key to create a digital signature on the message. Anyone with the sender's corresponding public key can perform the corresponding signature verification algorithm on the same message and the digital signature associated with it to verify whether the signature was valid (made by the owner of the corresponding private key). Examples of PKE techniques include Diffie-Helman, Digital Signature Algorithm (DSA), Rivest-Shamir Adelman (RSA), ElGamal, Elliptic Curve Cryptography, Paillier cryptosystem, Cramer-Shoup cryptosystem, YAK authenticated key agreement protocol, among others.

The communication between the sender 102 and receiver 104 are now described with the sender 102 as source and the receiver as the destination. The roles of source and destination can be reversed.

The sender 102 can generate a public key and private key pair, such as by the processing circuitry 120A. The sender 102 can hash the public key to generate a public key hash 118. The sender 102 can provide the public key hash 118 to the KSI infrastructure 106. The KSI infrastructure 106 can provide a KSI signature 110 to the sender 102.

The sender 102 can, by the communications circuitry 118A, provide the public key 108 and the corresponding KSI signature 110 to the receiver 104. The receiver 104 can verify that the KSI signature 110 for the public key 108 is valid.

The receiver 104 can indicate to the sender 102 whether the KSI signature 110 passed verification. This indication can include an acknowledge (ACK), a negative acknowledge (NACK), or the like. If the receiver provides the ACK, communications between the sender 102 and receiver 104 can begin using PKE. PKE can be performed using the public key 108 and the corresponding private key. The private key can be used to encrypt a message 112 (or a hash of the message 112 in the example of FIG. 1).

The sender 102 can provide the message 112 (or an encrypted version of the message 112) to the receiver 104. The sender 102 can provide (e.g., simultaneously, sequentially, asynchronously, or the like) the message 112 (or an encrypted version of the message) and the message signature 116. Most signing techniques hash the message before generating the signature.

The receiver 104 can receive, by the communications circuitry 118B, the communications from the sender 102. The receiver 104 can, by the processing circuitry 120B, verify whether the KSI signature 110 is accurate. If the KSI signature 110 is not verified, the receiver 104 can discard further communications from the sender 102, re-try sending the communication, drop the corrupted communication and notify the sender, stop accepting communications from the sender, or the like. The reaction to a failed verification attempt can be defined by a policy indicating how to deal with the failed verification.

The communications circuitry 118A, 118B can include electric or electronic components configured to send and receive wired or wireless communications and interpret data therefrom. The communications circuitry 118A, 118B can modulate or demodulate a wave to add data to, or determine data provided by the wave. The electric or electronic components can include one or more resistors, transistors, capacitors, diodes, inductors, amplifiers, antennas, modulators, demodulators, oscillators, buffers, power supplies, analog to digital converters (ADC), digital to analog converters (DAC), logic gates (e.g., AND, OR, XOR, negate, etc.), multiplexers, switches, a combination thereof, or the like.

The processing circuitry 120A, 120B can include one or more electric or electronic components configured to control the communications circuitry 118A, 118B, respectively or perform other operations of the sender 102 or receiver 104. The processing circuitry 120A, 120B can be configured to verify the KSI signature 110 or verify the PKE signature. The electric or electronic components can include one or more resistors, transistors, capacitors, diodes, inductors, amplifiers, modulators, demodulators, oscillators, buffers, power supplies, analog to digital converters (ADC), digital to analog converters (DAC), logic gates (e.g., AND, OR, XOR, negate, etc.), multiplexers, switches, processing units (e.g., central processing units (CPUs), field programmable gate array (FPGA), application specific integrated circuit (ASIC), graphics processing unit (GPUs), a combination thereof, or the like.

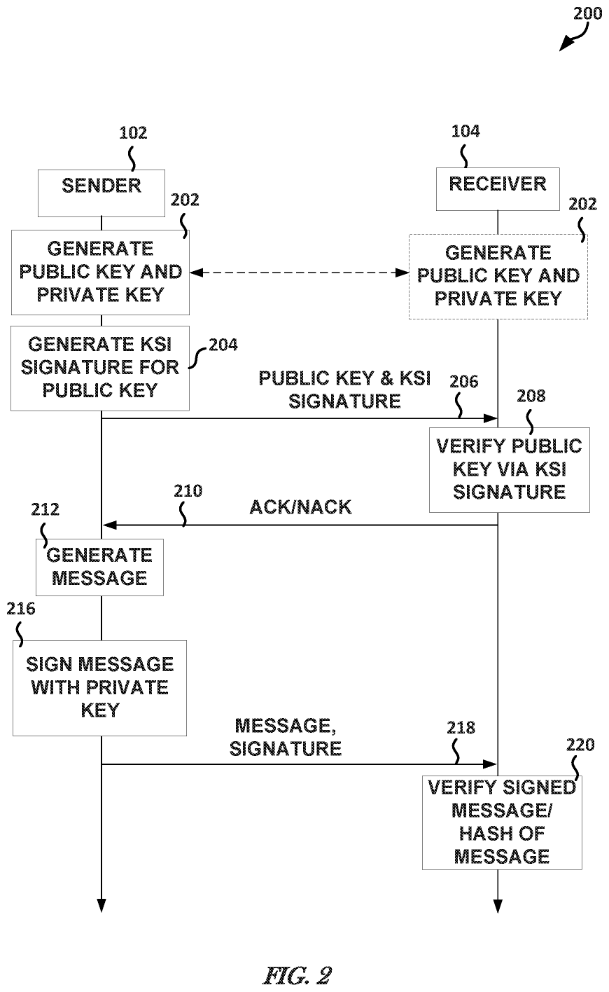

FIG. 2 illustrates, by way of example, a communication diagram of an embodiment of communication between the sender 102 and the receiver 104. The communications in FIG. 2 are illustrated by arrows and operations are indicated by boxes. Communications can be issued by the communications circuitry 118A, 118B and operations can be performed by the processing circuitry 120A, 120B.

At operation 202, the sender 102 and receiver 104, alone or in combination, can generate an asymmetric key pair, consisting of a public key (sometimes called a verification key) and a private key (sometimes called a signing key). The public key and private key can be generated using any known key generation technique. Note that not all public key encryption (PKE) techniques have the same strength. The strength of a PKE technique can be determined based on how long it takes to recover the private key via cryptanalysis based on a signed message and the public key. It is advantageous to use a PKE technique that takes more time to crack than the lifetime of the generated keys. When a public key and private key pair are valid for a shorter period of time before they are destroyed or no longer used, a weaker PKE technique can be used. When a public key and private key pair are valid for a longer period of time (relative to the shorter period of time) a stronger PKE technique can be used.

At operation 204, a KSI signature 110 can be generated for the public key 108 or a value used to generate the public key 108 (as in Diffie-Helman cryptography or the like). The public key 108 or the value used to generate the public key 108 can be hashed and provided to the KSI infrastructure 106. The KSI infrastructure can return the KSI signature 110.

At communication 206, the public key 108 and the KSI signature 110 can be provided to the receiver 104. At operation 208, the receiver 104 can verify integrity of the public key 108 using the KSI signature 110. This is possible because the KSI infrastructure 106 retains history of the hashes used to generate the top-level KSI signature that is generated once per second.

A communication 210 can be provided, to the sender 102 and by the receiver 104, indicating whether the KSI signature 110 is verified. The communication 210 can indicate the KSI signature 110 is verified using an ACK. The communication 210 can indicate the KSI signature 110 is not verified using a NACK. After receiving confirmation that the KSI signature 110 is verified, the sender 102 can begin communicating with the receiver 104 using the generated public and private key pair.

If the KSI signature 110 does not match, that means there was either an error in communication or a bad actor has corrupted the public key 108, the KSI signature 110, or both. The receiver 104 can provide the NACK in the communication 210 if the KSI signatures does not pass verification.

The operations 202, 204, and 208, along with the communication 206 can protect against corruption of the public key 108. The communication of the public key 108 at communication 206 can be intercepted by a bad actor. The bad actor can then replace the public key 108 with an arbitrary public key of their choosing, thus enabling the bad actor to impersonate the sender. This is an important, sometimes unacceptable vulnerability in PKE that the operations 202, 204, 208 and communications 206, 210 guard against.

After operation 208 or the communication 210, the sender 102 or the receiver 104 can go to a geographic location or enter a state in which they do not have communication with the KSI infrastructure 106. This can include turning off a connection, port, or antenna coupled to the network over which the sender 102 or receiver 104 communicate with the KSI 106, moving to a geographic location that is out of communication range of the KSI 106, or the like. A PKE technique can then reliably be used for communication while the sender 102 and/or receiver 104 are not capable of communicating with the KSI 106.

The sender 102 or receiver 104 can perform operations while they cannot (intentionally or unintentionally) communicate with the KSI 106. During such operations, the sender 102 or receiver 104 can gather, receive, or generate data and sign it using PKE (whichever PKE technique is being used). After the sender 102 or receiver 104 come back into communication range, or after the sender 102 or receiver 104 restore the capability to communicate with the KSI 106, the data (e.g., communications or instructions to or from another device, information gathered or generated by the device, log information regarding the internal operation of the device or the like) during the mission can be persistently signed using the KSI 106. The data can then be stored with the KSI signature for long term persistent, immutable data integrity.

At operation 212, the sender 102 can generate a message to be provided to the receiver 104.

At operation 216, the sender 102 can sign the message generated at operation 212. At the communication 218, the sender 102 can provide the message (generated at operation 212), and the signature of the message (generated at operation 216) to the receiver 104, such as in a single or multiple messages.

The receiver 104 can verify, at operation 220, the PKE signature (using the public key 108) of the provided message or hash of the message.

Using the operations and communications after the communication 210 in the communication diagram of FIG. 2, a technique for low latency (e.g., less than four (4) seconds) immutable data integrity can be provided.

Some PKE protocols include cooperation between a sender and receiver to generate key pairs. For example, Diffie-Helman cryptography includes both parties publicly agreeing on a number with certain properties. Then each of the parties chooses a secret number with certain properties. The publicly agreed upon number and the secret number are then mathematically combined to generate two new numbers. These numbers are exchanged and combined with the secret numbers to generate the same number. Other cryptographic signing techniques can include similar interaction among the parties. Using such a technique, the sender 102 or receiver 104 can sign each of the communications to the receiver 104 or sender 102 using KSI, instead of just signing the resultant key. In this manner, the same low latency immutable data integrity can be achieved as is achieved with KSI signing of just the public key (in instances in which the sender 102 alone generates the asymmetric key pair).

In a keyless signature system, the functions of signer identification and of evidence integrity protection are separated and delegated to cryptographic tools suitable for those functions. While the nature of the KSI system can be used to validate the sender, KSI may not be the sole means for sender validation.

In KSI, keyless signatures are implemented in practice as multi-signatures, (e.g., many data items from multiple users are signed at a given time). The signing process involves the steps of:

1. Hashing: The documents to be signed are hashed and the hash values are used to represent the documents in the rest of the process.

2. Aggregation: A per-round aggregation hash tree is created to represent all documents signed during the round. The duration of rounds may vary but is set to one second in the working solution to KSI.

3. Publication: The root hash values of the per-round aggregation trees are collected into a perpetual hash tree (so-called hash calendar) and the root hash value of that tree is published as a trust anchor.

One can use a KSI infrastructure, authentication, non-repudiation, in any of those scenarios. To use such signatures in practice, one uses a suitable KSI infrastructure analogous to PKI for traditional signature solutions. Such a KSI infrastructure includes a hierarchy of aggregation servers that, in co-operation, create the per-round global hash trees. First layer aggregation servers, sometimes called gateways, are responsible for collecting requests directly from clients, and all other aggregation servers receive requests from a set of lower level servers, hashes them together into a single resultant hash value, and sends this single resultant hash value to higher-level servers.

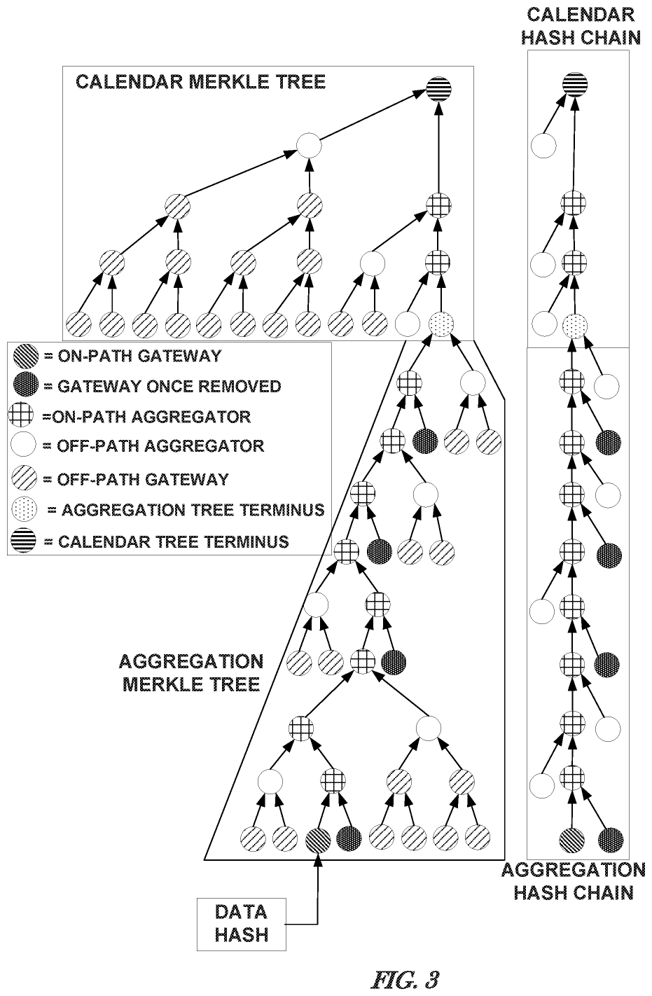

FIG. 3 illustrates, by way of example, a diagram of an embodiment of the KSI infrastructure 106. The KSI infrastructure 106 includes gateways, aggregators, and a core cluster. The gateways provide a customer an entry point into the KSI infrastructure 106. A customer hashes their data using a specified hash function (typically SHA-512) and provides the hashed data to the gateway. An aggregator receives hashed data from multiple gateways, concatenates the received data, and hashes the concatenated data. Input provided to an aggregator can include data from a gateway or another aggregator.

By connecting aggregators and gateways, a hierarchy, that resembles a tree structure, is formed. This tree is called an aggregation Merkle tree. The aggregation Merkle tree is a distributed network of compute nodes that compute hash values and provide the hash values to a pre-determined next computer. The aggregation Merkle tree terminates at a top-level aggregator (aggregation tree terminus).

The top-level aggregator is a leaf node of a core cluster. The core cluster includes compute nodes coupled in a calendar Merkle tree. The calendar Merkle tree includes nodes connected similar to the aggregation Merkle tree but provides a demarcation for generating a portion of a KSI signature. The core cluster includes a core node (calendar tree terminus) to which all gateways and aggregators are eventually coupled.

The KSI signature is defined, at least partially, by the aggregators (and gateway) through which the data hash passed and aggregators that provided direct input to the aggregators through which the data hash passed before reaching the top-level aggregator of the calendar Merkle tree and the aggregation Merkle tree, respectively. By KSI signing the public key, the sender 102 can provide an integrity guarantee to the receiver 104 that the public key 102 is valid and to be used in communication.

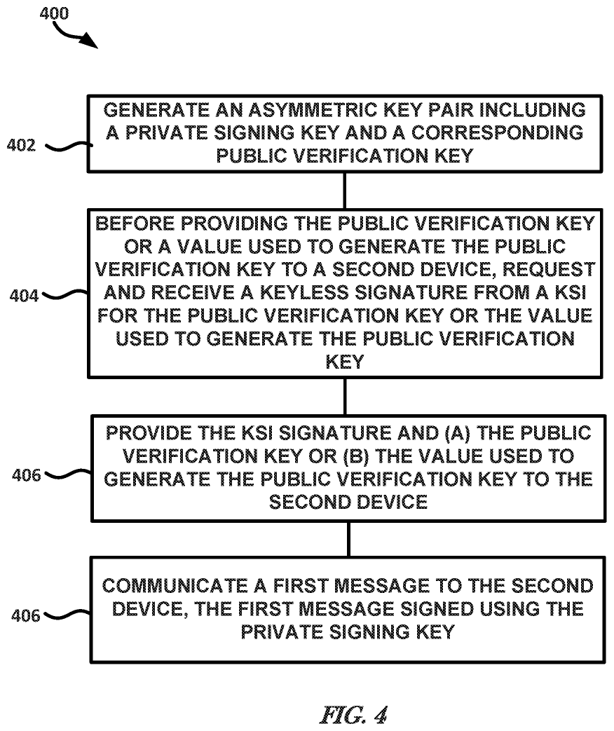

FIG. 4 illustrates, by way of example, a diagram of an embodiment of a method 400. The method 400 can be implemented using one or more of the components or operations of FIGS. 1-3. The method 400 as illustrated includes generating, at least partially by a first device, an asymmetric key pair including a private signing key and a corresponding public verification key, at operation 402; before providing the public verification key or a value used to generate the public verification key to a second device, requesting and receiving a keyless signature from a keyless signature infrastructure (KSI) for the public verification key or a value used to generate the public verification key, at operation 404; providing the KSI signature and (a) the public verification key or (b) the value used to generate the public verification key to the second device, at operation 406; and communicating a first message to the second device, the message signed using the private signing key, at operation 408.

The method 400 can further include before communicating the message, receiving a second message from the second device indicating that the KSI signature is verified and wherein communicating the first message includes only communicating the message after receiving the second message from the second device. The method 400 can further include requesting and receiving a second keyless signature from the KSI for the second message and verifying the second message based on the second keyless signature.

The method 400 can further include, before communicating the message to the second device, receiving a message from the second device indicating that the KSI signature is not verified. The method 400 can further include re-sending the KSI signature in response to receiving the message from the second device. The method 400 can further include, in response to receiving the message from the second device: generating a new asymmetric key pair including a new public verification key and a new private signing key. The method 400 can further include, before providing the new public verification key to a second device, requesting and receiving a keyless signature infrastructure (KSI) signature for the new public verification key. The method 400 can further include providing the new public verification key and the KSI signature to the second device.

The method 400 can further include operating without capability to communicate with a KSI that issued the KSI signature after receiving the message indicating the KSI signature is verified. The method 400 can further include while operating without the capability to communicate with the KSI, collecting data. The method 400 can further include restoring the capability to communicate with the KSI. The method 400 can further include signing the data collected while operating without the capability to communicate with the KSI with a second KSI signature. The method 400 can further include stripping PKE signatures from the data before signing the data. Stripping PKE signatures from the data before signing the data can remove PKE signatures from the gathered data. Data before stripping can include {data0, PKE0, data1, PKE1 . . . , dataN, PKEN}. Data after stripping the PKE signatures would then be {data0, data1 . . . , dataN}.

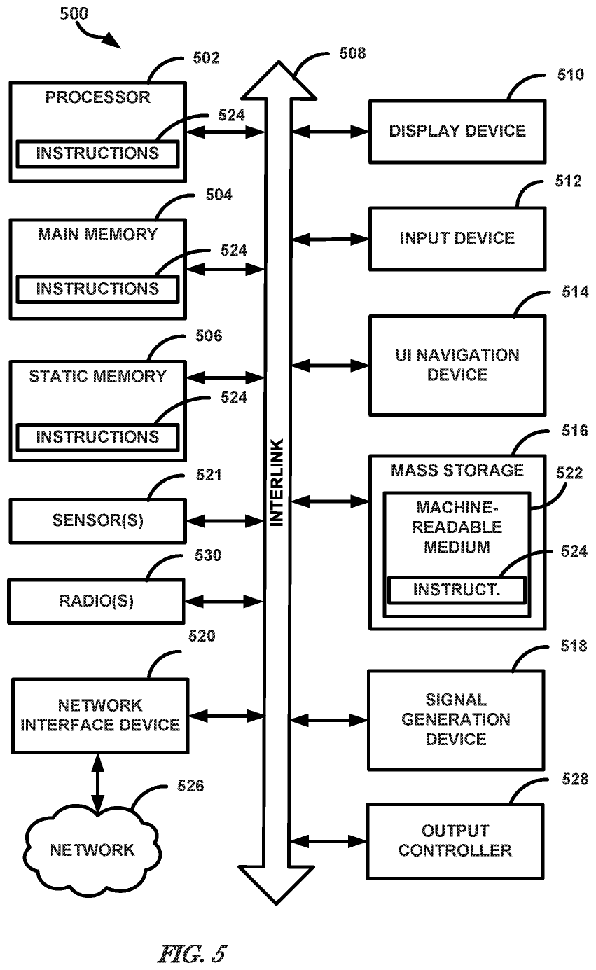

FIG. 5 illustrates, by way of example, a block diagram of an embodiment of a machine in the example form of a computer system 500 within which instructions, for causing the machine to perform any one or more of the methodologies discussed herein, may be executed. One or more of the sender 102, receiver 104 or other device or component of FIGS. 1-3, can be implemented using, or can include, one or more components of the system 500. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, an embedded system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a mass storage unit 516, a signal generation device 518 (e.g., a speaker), a network interface device 520, and a radio 530 such as Bluetooth, WWAN, WLAN, and NFC, permitting the application of security controls on such protocols.

The mass storage unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 524 may further be transmitted or received over a communications network 526 using a transmission medium. The instructions 524 may be transmitted using the network interface device 520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any tangible or intangible medium that is capable of storing, encoding or carrying instructions for execution by the machine, and includes digital or analog communications signals or other intangible media to facilitate communication of such software.

### ADDITIONAL NOTES AND EXAMPLES

Example 1 can include a method of secure communication comprising generating, at least partially by a first device, an asymmetric key pair including a private signing key and a corresponding public verification key, before providing the public verification key or a value used to generate the public verification key to a second device, requesting and receiving a keyless signature from a keyless signature infrastructure (KSI) for the public verification key or a value used to generate the public verification key, providing the KSI signature and (a) the public verification key or (b) the value used to generate the public verification key to the second device, and communicating a first message to the second device, the message signed using the private signing key.

In Example 2, Example 1 can further include, before communicating the message, receiving a second message from the second device indicating that the KSI signature is verified and wherein communicating the first message includes only communicating the message after receiving the second message from the second device.

In Example 3, Example 2 can further include requesting and receiving a second keyless signature from the KSI for the second message and verifying the second message based on the second keyless signature.

In Example 4, at least one of Examples 1-3 can further include before communicating the message to the second device, receiving a message from the second device indicating that the KSI signature is not verified.

In Example 5, Example 4 can further include re-sending the KSI signature in response to receiving the message from the second device.

In Example 6, at least one of Examples 4-5 can further include, in response to receiving the message from the second device generating a new asymmetric key pair including a new public verification key and a new private signing key, before providing the new public verification key to a second device, requesting and receiving a keyless signature infrastructure (KSI) signature for the new public verification key, and providing the new public verification key and the KSI signature to the second device.

In Example 7, at least one of Examples 2-6 can further include operating without capability to communicate with a KSI that issued the KSI signature after receiving the message indicating the KSI signature is verified.

In Example 8, Example 7 can further include, while operating without the capability to communicate with the KSI, collecting data, restoring the capability to communicate with the KSI, and signing the data collected while operating without the capability to communicate with the KSI with a second KSI signature.

In Example 9, Example 8 can further include stripping PKE signatures from the data before signing the data.

Example 10 can include a non-transitory machine-readable medium including instructions that, when executed by a machine, cause the machine to perform the method of at least one of Examples 1-9.

Example 11 can include a system including processing circuitry and a memory coupled to the processing circuitry and including instructions that, when executed by the processing circuitry, cause the processing circuitry to perform the method of at least one of Examples 1-9.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method of secure communication comprising:
generating, at least partially by a first device, an asymmetric key pair including a private signing key and a corresponding public verification key;
before providing the public verification key or a value used to generate the public verification key to a second device, requesting and receiving a keyless signature from a keyless signature infrastructure (KSI) for the public verification key or a value used to generate the public verification key;
providing the KSI signature and (a) the public verification key or (b) the value used to generate the public verification key to the second device; and
communicating a first message to the second device, the first message signed using the private signing key.

2. The method of claim 1, further comprising before communicating the first message, receiving a second message from the second device indicating that the KSI signature is verified and wherein communicating the first message includes only communicating the first message after receiving the second message from the second device.

3. The method of claim 2, further comprising requesting and receiving a second keyless signature from the KSI for the second message and verifying the second message based on the second keyless signature.

4. The method of claim 1, further comprising:
before communicating the first message to the second device, receiving a second message from the second device indicating that the KSI signature is not verified.

5. The method of claim 4, further comprising re-sending the KSI signature in response to receiving the second message from the second device.

6. The method of claim 4, further comprising in response to receiving the second message from the second device:
generating a new asymmetric key pair including a new public verification key and a new private signing key;
before providing the new public verification key to a second device, requesting and receiving a keyless signature infrastructure (KSI) signature for the new public verification key; and
providing the new public verification key and the KSI signature to the second device.

7. The method of claim 2, further comprising operating without capability to communicate with a KSI that issued the KSI signature after receiving the second message indicating the KSI signature is verified.

8. The method of claim 7, further comprising:
while operating without the capability to communicate with the KSI, collecting data;
restoring the capability to communicate with the KSI; and
signing the data collected while operating without the capability to communicate with the KSI with a second KSI signature.

9. The method of claim 8, further comprising stripping PKE signatures from the data before signing the data.

10. A non-transitory machine-readable medium including instructions that, when executed by a machine, cause the machine to perform operations for secure communication, the operations comprising:
generating, at least partially by a first device, an asymmetric key pair including a private signing key and a corresponding public verification key;
before providing the public verification key or a value used to generate the public verification key to a second device, requesting and receiving a keyless signature from a keyless signature infrastructure (KSI) for the public verification key or a value used to generate the public verification key;
providing the KSI signature and (a) the public verification key or (b) the value used to generate the public verification key to the second device; and
communicating a first message to the second device, the first message signed using the private signing key.

11. The non-transitory machine-readable medium of claim 10, wherein the operations further comprise before communicating the first message, receiving a second message from the second device indicating that the KSI signature is verified and wherein communicating the first message includes only communicating the first message after receiving the second message from the second device.

12. The non-transitory machine-readable medium of claim 11, wherein the operations further comprise requesting and receiving a second keyless signature from the KSI for the second message and verifying the second message based on the second keyless signature.

13. The non-transitory machine-readable medium of claim 10, wherein the operations further comprise, before communicating the first message to the second device, receiving a second message from the second device indicating that the KSI signature is not verified.

14. The non-transitory machine-readable medium of claim 13, wherein the operations further comprise re-sending the KSI signature in response to receiving the second message from the second device.

15. The non-transitory machine-readable medium of claim 13, wherein the operations further comprise, in response to receiving the second message from the second device generating a new asymmetric key pair including a new public verification key and a new private signing key, before providing the new public verification key to a second device, requesting and receiving a keyless signature infrastructure (KSI) signature for the new public verification key, and providing the new public verification key and the KSI signature to the second device.

16. A system comprising:
processing circuitry; and
a memory coupled to the processing circuitry and including instructions stored thereon that, when executed by the processing circuitry, cause the processing circuitry to perform operations for secure data communication, the operations comprising:
generating, at least partially by a first device, an asymmetric key pair including a private signing key and a corresponding public verification key;
before providing the public verification key or a value used to generate the public verification key to a second device, requesting and receiving a keyless signature from a keyless signature infrastructure (KSI) for the public verification key or a value used to generate the public verification key;
providing the KSI signature and (a) the public verification key or (b) the value used to generate the public verification key to the second device; and
communicating a first message to the second device, the first message signed using the private signing key

17. The system of claim 16, wherein the operations further comprise, before communicating the first message, receiving a second message from the second device indicating that the KSI signature is verified and wherein communicating the first message includes only communicating the first message after receiving the second message from the second device.

18. The system of claim 17, further comprising operating without capability to communicate with a KSI that issued the KSI signature after receiving the second message indicating the KSI signature is verified.

19. The system of claim 18, wherein the operations further comprise:
while operating without the capability to communicate with the KSI, collecting data;
restoring the capability to communicate with the KSI; and
signing the data collected while operating without the capability to communicate with the KSI with a second KSI signature.

20. The system of claim 19, wherein the operations further comprise stripping PKE signatures from the data before signing the data.
